(19) United States
(12) Patent Application Publication
(10) Pub. No.: US 2024/0270203 A1
(43) Pub. Date: Aug. 15, 2024

(54) SEATBELT MONITORING SYSTEM

(71) Applicant: Eddie Thomas, New Orleans, LA (US)

(72) Inventor: Eddie Thomas, New Orleans, LA (US)

(21) Appl. No.: 18/110,239

(22) Filed: Feb. 15, 2023

(51) Int. Cl. B60R 22/48; B60R 16/033

(52) U.S. Cl. CPC B60R 22/48; B60R 16/033; B60R 2022/4816; B60R 2022/4875

(57) ABSTRACT

A seatbelt monitoring system for warning nearby individuals that a driver's seatbelt is unbuckled includes an engine sensor for determining when a motor of an automobile is activated and a seatbelt sensor for determining when a driver seatbelt is buckled. An indicator light centered on a rear end of the automobile emits a red light when the driver seatbelt is unbuckled and the motor is activated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to seatbelt monitoring systems and more particularly pertains to a new seatbelt monitoring system for warning nearby individuals, exteriorly positioned from a vehicle, that a driver's seatbelt within the vehicle is unbuckled.

### (2) Description of Related Art Including Information Disclosed Under 37 CFR 1.97 and 1.98

The prior art relates to seatbelt monitoring systems. U.S. Pat. No. 9,260,054 discloses an indicator light that appears in the rear window of a vehicle which illuminates when the vehicle's ignition switch is in the on position, the vehicle is in any forward or reverse gear, and the driver's seatbelt is unfastened. U.S. Pat. No. 10,850,701 discloses a light emitter which directs a light rearwardly of a vehicle when a pressure sensor in the driver's seat detects the presence of a person sitting in the seat and the driver's seatbelt is unbuckled. U.S. Pat. No. 10,173,639 discloses a visual indicator which emits light rearwardly of an automobile when an internal seatbelt reminder signal is illuminated. U.S. Pat. Application No. 2021/0291725 discloses a seatbelt compliance light that is externally mounted to a motor vehicle which illuminates when occupancy sensors for the seats of the motor vehicle detect occupants in the seats and detectors sense that the seatbelts for the occupied seats are buckled.

### BRIEF SUMMARY OF THE INVENTION

An embodiment of the disclosure meets the needs presented above by generally comprising an automobile including a driver seatbelt that has a first mating member and a second mating member. The first mating member is engageable with the second mating member to be removably coupled to the second mating member. A control circuit is coupled to and positioned within the automobile. An engine sensor is electrically coupled to the control circuit and is associated with the automobile. The engine sensor is configured to transmit a first signal to the control circuit when a motor of the automobile is activated. A seatbelt sensor is electrically coupled to the control circuit and is associated with the driver seatbelt. The seatbelt sensor is configured to transmit a second signal to the control circuit when the first mating member is decoupled from the second mating member. An indicator lamp is coupled to an exterior of the automobile and is electrically coupled to the control circuit. The indicator lamp activates to emit light when the control circuit receives both of the first signal and the second signal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top rear side perspective view of a seatbelt monitoring system according to an embodiment of the disclosure.

FIG. 2A is an in-use view of an embodiment of the disclosure with the driver seatbelt unbuckled and the indicator lamp emitting light.

FIG. 2B is an in-use view of an embodiment of the disclosure with the driver seatbelt buckled and the indicator lamp not emitting light.

FIG. 3 is a block diagram of an embodiment of the disclosure.

### DETAILED DESCRIPTION OF THE INVENTION

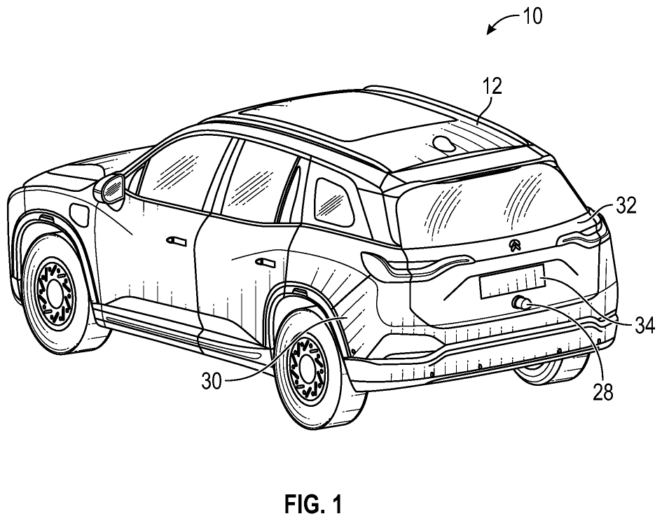

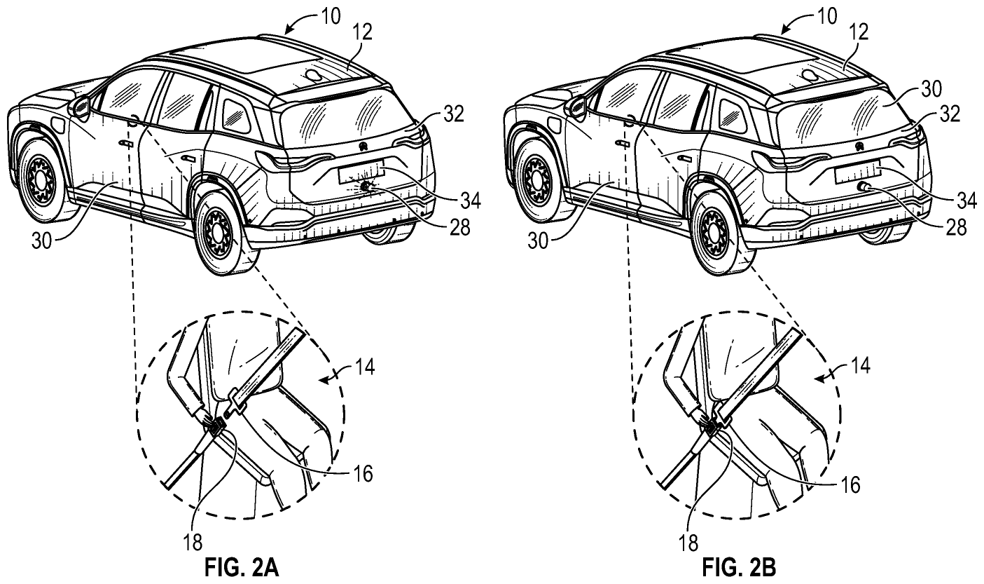

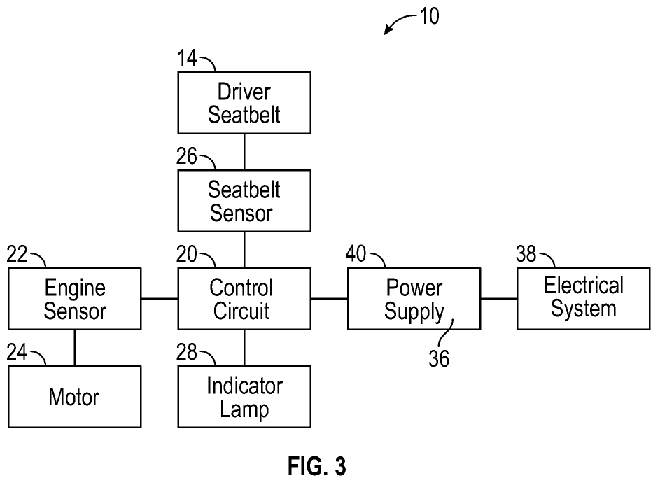

With reference now to the drawings, and in particular to FIGS. 1 through 3 thereof, a new seatbelt monitoring system embodying the principles and concepts of an embodiment of the disclosure and generally designated by the reference numeral 10 will be described.

As best illustrated in FIGS. 1 through 3, the seatbelt monitoring system 10 generally comprises an automobile 12 including a driver seatbelt 14 that has a first mating member 16 and a second mating member 18. The first mating member 16 is engageable with the second mating member 18 to be removably coupled to the second mating member 18. A control circuit 20 is coupled to and positioned within the automobile 12. An engine sensor 22 is electrically coupled to the control circuit 20 and is associated with the automobile 12. The engine sensor 22 is configured to transmit a first signal to the control circuit 20 when a motor 24 of the automobile 12 is activated. A seatbelt sensor 26 is electrically coupled to the control circuit 20 and is associated with the driver seatbelt 14. The seatbelt sensor 26 is configured to transmit a second signal to the control circuit 20 when the first mating member 16 is decoupled from the second mating member 18.

An indicator lamp 28 is coupled to an exterior 30 of the automobile 12 and is electrically coupled to the control circuit 20. The indicator lamp 28 activates to emit light when the control circuit 20 receives both of the first signal and the second signal. The indicator lamp 28 is positioned on a rear end 32 of the automobile 12 and is laterally centered on the rear end 32. The automobile 12 has a license plate mount 34 positioned adjacently above the indicator lamp 28. The indicator lamp 28 is configured for generating red light when activated. A power supply 36 is electrically coupled to the control circuit 20. The power supply 36 comprises a battery 40 of an electrical system 38 of the automobile 12.

In use, the seatbelt monitoring system 10 operates automatically to indicate when the motor 24 is activated and the first mating member 16 of the driver seatbelt 14 is decoupled from the second mating member 18. The engine sensor 22 transmits the first signal to the control circuit 20 when the motor 24 is activated, and the seatbelt sensor 26 transmits the second signal when the first mating member 16 is decoupled from the second mating member 18. When both of the first and second signals are received by the control circuit 20, the control circuit 20 activates the indicator lamp 28 to emit red light, warning nearby individuals that the driver seatbelt 14 is unbuckled.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A seatbelt monitoring system comprising:
an automobile including a driver seatbelt, the driver seatbelt having a first mating member and a second mating member, the first mating member being engageable with the second mating member to be removably coupled to the second mating member;
a control circuit being coupled to and positioned within the automobile;
an engine sensor being electrically coupled to the control circuit and being associated with the automobile, the engine sensor being configured to transmit a first signal to the control circuit when a motor of the automobile is activated;
a seatbelt sensor being electrically coupled to the control circuit and being associated with the driver seatbelt, the seatbelt sensor being configured to transmit a second signal to the control circuit when the first mating member is decoupled from the second mating member; and
an indicator lamp being coupled to an exterior of the automobile and being electrically coupled to the control circuit, the indicator lamp activating to emit light when the control circuit receives both of the first signal and the second signal.

2. The system of claim 1, wherein the indicator lamp is positioned on a rear end of the automobile.

3. The system of claim 2, wherein the indicator lamp is laterally centered on the rear end.

4. The system of claim 3, wherein the automobile has a license plate mount positioned adjacently above the indicator lamp.

5. The system of claim 1, wherein the indicator lamp is configured for generating red light when activated.

6. The system of claim 1, further comprising a power supply being electrically coupled to the control circuit, the power supply comprising a battery of an electrical system of the automobile.

7. A seatbelt monitoring system comprising:
an automobile including a driver seatbelt, the driver seatbelt having a first mating member and a second mating member, the first mating member being engageable with the second mating member to be removably coupled to the second mating member;
a control circuit being coupled to and positioned within the automobile;
an engine sensor being electrically coupled to the control circuit and being associated with the automobile, the engine sensor being configured to transmit a first signal to the control circuit when a motor of the automobile is activated;
a seatbelt sensor being electrically coupled to the control circuit and being associated with the driver seatbelt, the seatbelt sensor being configured to transmit a second signal to the control circuit when the seatbelt sensor is first mating member from the second mating member;
an indicator lamp being coupled to an exterior of the automobile and being electrically coupled to the control circuit, the indicator lamp activating to emit light when the control circuit receives both of the first signal and the second signal, the indicator lamp being positioned on a rear end of the automobile, the indicator lamp being laterally centered on the rear end, the automobile having a license plate mount positioned adjacently above the indicator lamp, the indicator lamp being configured for generating red light when activated; and
a power supply being electrically coupled to the control circuit, the power supply comprising a battery of an electrical system of the automobile.
